(19) United States
(12) Patent Application Publication
(10) Pub. No.: US 2010/0236725 A1
(43) Pub. Date: Sep. 23, 2010

(54) FAST DOOR WITH FLEXIBLE SCREEN

(75) Inventor: Bernard KRAEUTLER, Dunieres (FR)

Correspondence Address: CANTOR COLBURN, LLP, 20 Church Street, 22nd Floor, Hartford, CT, 06103, US

(73) Assignee: NERGECO, Dunieres (FR)

(21) Appl. No.: 12/664,138

(22) PCT Filed: Jun. 11, 2008
(86) PCT No.: PCT/IB08/01500

§ 371 Date: May 5, 2010

(30) Foreign Application Priority Data
Jun. 11, 2007 (FR) 0704149

(51) Int. Cl. E05F 15/20; E06B 3/80

(52) U.S. Cl. 160/1; 160/371

(57) ABSTRACT

This fast door (1) being able to close off an opening made in a partition comprises: a structure having notably two vertical uprights (3) in each of which a slide (5) is arranged, and a top horizontal element forming a lintel, and a flexible screen (12) connected to the structure at the element forming a lintel by electromechanical means controlling the lowering and the raising of the screen (12), control means for controlling the electromechanical means controlling the movement of the screen (12). According to the invention, at its bottom transverse end, the flexible screen (12) is fitted: with a ballasting element that is rectilinear and flexible in a vertical plane and in a horizontal plane, capable of deforming and then resuming its rectilinear shape after a contact with an object placed on the trajectory of the screen (12) or encountering the latter, and contact detection means positioned between the flexible ballasting element (14) and the bottom free end of the screen (12) connected to the control means and having a normal operating state and an abnormal operating state, the detection means being associated with the flexible ballasting element (14), and being capable of switching from the normal operating state to the abnormal operating state when there is a contact of the screen with a static or moving object placed on the trajectory of the screen (12) by a deformation of the flexible ballasting element (14) or of the bottom free end of the screen, the change of state of the detection means being converted into a signal that is transmitted to the control means for the purpose of ordering the stoppage and/or the raising of the screen to its open position by resuming its normal trajectory, and doing this with no external intervention on the flexible ballasting element (14) nor on the control means, nor on the screen (12), nor on the slides (5).

### TECHNICAL FIELD

The present invention relates to a fast door provided with a flexible screen with which passing through an opening made in a partition may be prevented or authorized.

### BACKGROUND

For several decades, doors, so-called fast doors, have been known, which have a screen cut in a flexible material such as a PVC web. Because of the low inertia of their screen, these doors may open and close at high speed. These fast doors notably contribute to limiting heat losses when they close the access to heated premises.

These doors have a high action speed which may be of the order of 1 m/s which results in that the impact of the screen with a person or equipment during the closing of the door may be extremely damageable for the person or the equipment.

Over the years, a passive approach has been developed for handling collisions with a fast door screen; this approach aims at minimizing the consequences of a collision, for example by providing a screen with a very flexible doorway bar capable of absorbing the energy of the collision.

An active approach has also been developed for handling collisions with a flexible screen aiming at preventing the occurrence of a collision with the screen. This approach is notably materialized by screens provided with a rigid bottom bar against which a feeler is positioned. In the case of collision between the screen and a person or an object, the feeler is crushed against the bottom bar of the screen; the crushing of the feeler is converted into an electric signal which generally controls the rising of the screen. This type of detection is however unsuitable for fast doors, the screen of which moves at great speed. Taking into account the speed of motion of the screen, the triggering of the feeler may itself cause an injury or damage, since it is subordinated to counter-pressure against a rigid bar.

It therefore appears that improvements may be made to present fast doors in the taking into account of accidental collisions.

### BRIEF SUMMARY

The disclosure proposes a fast door with a flexible screen which, while being capable of controlling fast movement of the screen, may further have secured operation for the persons and equipment which pass through this door.

The disclosure particularly provides a fast door which may close off an opening made in a partition comprising:
a structure having notably two vertical uprights in each of which a slide is arranged, and a top horizontal element forming a lintel, and
a flexible screen connected to the structure at the element forming a lintel by electromechanical means controlling the lowering and the raising of the screen, so as to cause the screen to pass along a normal screen trajectory parallel to the plane defined by both slides, from a closed position in which the screen closes off the opening to an open position in which the screen clears the access of the opening, and vice versa,
means for controlling the electromechanical means controlling the movement of the screen.

Further, at its lower transverse end, the flexible screen is equipped:
with a ballasting element which is rectilinear and flexible in a vertical plane and in a horizontal plane, capable of deforming and then resuming its rectilinear shape after contact with an object placed on the trajectory of the screen or encountering the latter, and
contact detection means positioned between the flexible ballasting element and the bottom free end of the screen connected to the control means and having a normal operating state and an abnormal operating state, the detection means being associated with the flexible ballasting element, and being capable of switching from the normal operating condition to the abnormal operating condition when there is contact of the screen with a static or moving object placed on the trajectory of the screen by deformation of the flexible ballasting element or of the bottom free end of the screen, the change of the state of the detection means being converted into a signal which is transmitted to the control means with view to ordering stoppage and/or raising of the screen to its open position by resuming its normal trajectory, and this with no external intervention on the flexible ballasting element, nor on the control means, nor on the screen, nor on the slides.

The invention proposes according to other features of the invention that:
the screen has, at its bottom transverse end, a transverse compartment into which are integrated the flexible ballasting element and the collision detection means which are associated with it,
the flexible ballasting element and the detection means which are associated with it are suspended from the bottom transverse end of the screen,
the detection means are positioned at the periphery and in proximity to the flexible ballasting element,
the detection means are positioned relatively to the flexible ballasting element on an angular sector of about 120° on either side of the lower generatrix of the flexible ballasting element or of the bottom edge of the screen,
the detection means are positioned between the flexible ballasting element and the bottom free end of the screen,
the detection means switching from the normal operating state to the abnormal operating state by deformation of said detection means during the deformation of the flexible ballasting element or of the bottom edge of the screen,
the detection means switch from the normal operation state to the abnormal operating state by breaking a beam which propagates in or parallel to the flexible ballasting element,
the flexible ballasting element has a length at most equal to the distance separating both slides,
the flexible ballasting element is engaged into a slide at either one or both of its ends,
the ballasting element comprises a helically wound metal wire which may be engaged into a sheath,
the detection means comprise a deformable sealed tube in which pressurized air is stored and a pressure switch capable of measuring a change in pressure in the tube after collision between the screen and a static or moving object,
the detection means comprise a tube in a flexible deformable material which integrates an electric conductor inside which a rib is positioned also provided with an electric conductor, the rib coming into contact with the electric conductor during a collision between the screen and a static or moving object,
the detection means comprise a transmitter and a receiver which define a beam either inside or parallel to the flexible ballasting element, likely to be cut off during contact between the screen and a static or moving object,
the detection means are attached on the flexible ballasting element by a male and female assembling system of the dovetail type,
the screen has at its bottom transverse end, a bottom transverse strip formed by a panel of flexible material folded on itself so as to delimit the transverse compartment in which the flexible ballasting element and the collision detection means are positioned,
the flexible ballasting element integrates a first conductor and at least one second conductor which will come into contact with each other during a collision between the screen and a static or moving object,
the flexible ballasting element integrates a transmitter and a receiver which define a beam capable of being interrupted during a collision between the screen and the static or moving object,
the flexible ballasting element integrates an air tube connected to a pressure switch, capable of changing state during a collision between the screen and a static or moving object.

### BRIEF DESCRIPTION OF THE DRAWINGS

The invention so that it may be well understood, is described with reference to the drawing appended herewith, illustrating, as non-limiting examples, several embodiments of doors according to the invention.

FIG. 1 illustrates a front view of a door according to the invention,

FIG. 2 is a perspective view of a flexible ballasting element integrated into the bottom portion of a flexible screen,

FIG. 3 is a sectional view along III-III of FIG. 1,

FIG. 4 is a view of another embodiment of the obstacle detection means,

FIGS. 5 and 6 show another embodiment of the invention in a cross-sectional view and in a vertical view, respectively.

### DETAILED DESCRIPTION

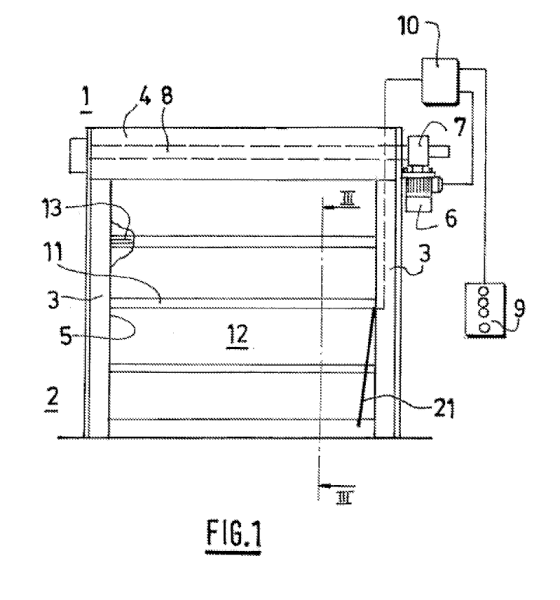

In order to begin the description of the invention, reference will initially be made to FIG. 1 which shows from the front, a door 1 standing against a partition 2 in which an opening is made.

This door comprises a structure consisting of mechanically welded and/or composite elements or further of an aluminium profile. The structure of the door in the illustrated example consists of two vertical uprights 3 which will frame the opening made in the partition 2 and of a top horizontal case 4 which forms the lintel of the door. Each upright 3 may have a slide 5.

At one of the uprights 3, an electromechanical assembly is positioned, notably comprising a motor 6 and a reducer 7; this electromechanical assembly drives a transverse shaft 8 which lies on bearings arranged at the upper end of each of the uprights 3. The transverse shaft 8 is protected by the top horizontal case 4. A control console 9 is connected to control means which usually comprise control electronics 10 which transmit control instructions to the electromechanical assembly. The closing-off of the opening delimited by the uprights 3 and by the top horizontal case 4 is achieved with a flexible screen 12; the flexible screen 12 may be made in a material of the PVC web type. In order to ensure the side seal of the door, provision is made for the possibility of having the side edges of the flexible screen 12 engage into the slides 5 which may be found in each of the uprights. Depending on the field of application of the door, the screen 12 may possibly be equipped with one or more transverse bars 13 which are engaged in sheaths 11 positioned on the screen. The transverse bars 13 may be rigid or may have global flexibility.

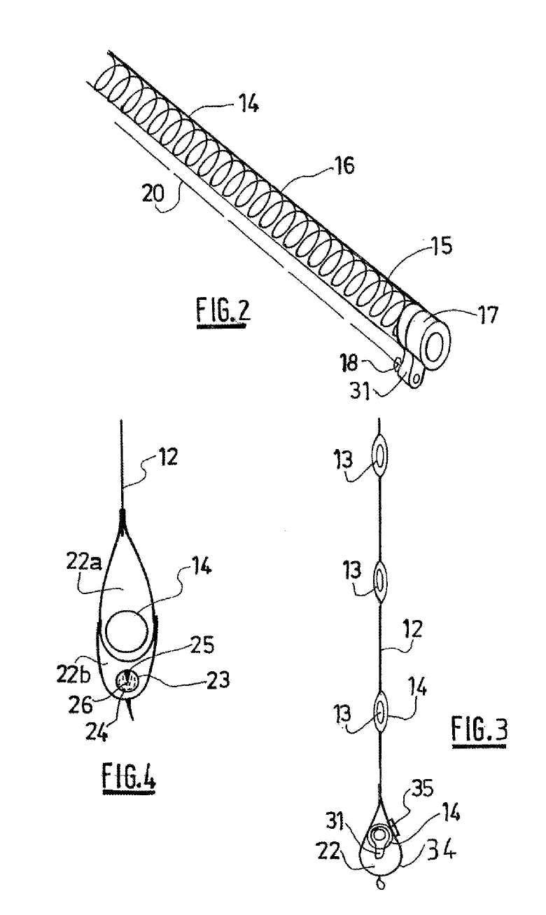

FIG. 3 which shows the screen 12 of the door 1 as a sectional view, shows a remarkable arrangement of the invention. This figure illustrates an embodiment of a door in which a flexible ballasting element 14 is positioned at the bottom end of the screen 12. The flexible ballasting element 14 may comprise a central portion consisting of a metal coil spring 15 inserted in a tubular foam sheath 16. At each of its ends, the flexible ballasting element may be extended with two side portions 17 which may notably consist of tubes: these tubes for example are steel tubes onto which the spring 15 may be welded. The making of tubes in a composite material may also be contemplated.

In this embodiment of the flexible ballasting element 14, the flexibility of the latter is given to it by the spring 15 which forms the central portion thereof. The fact that the flexible ballasting element 14 which therefore forms the lower portion of the screen 12 has high flexibility, is a very favorable point in handling a collision between the screen 12 and for example a person.

In the illustrated embodiment, it is envisioned to associate with the flexible ballasting element 14, contact detection means which operate in this example, optoelectronically. For this purpose, two consoles 31 may be provided, positioned at each of the two ends of the flexible ballasting element 14 which respectively receive a transmitter 18 and a receiver between which a beam 20 is established, which is a light beam in the present case. The transmitter 18—receiver pair is connected through a link which may be wired 21 or a radio link, to the control electronics 10 of the screen. In its normal operating state, the beam 20 is parallel to the flexible ballasting element 14.

The beam 20 is broken in the case of collision between the screen 12 and an object which is found on the trajectory plane of the screen 12. It should be noted that the collision may occur between a static object or a moving object which will strike the bottom of the screen 12. The breaking of the beam 20 which corresponds to an abnormal operating state of the detection means is transcribed into an electric signal which is transmitted via the wired or radio link to the control electronics 10 of the screen; the door is then placed in an abnormal operating mode which may generally comprise the action of raising the screen; other actions may be engaged such as for example the triggering of a visual or/and sound alarm.

FIG. 3 more particularly shows the flexible ballasting element 14 positioned on the bottom edge of the screen 12. It may thus be provided that the screen 12 on its lower portion, has a tarpaulin 34 which will delimit a compartment 22; into the compartment 22, the flexible ballasting element 14 is inserted like the one illustrated in FIGS. 2 and 3 with which optoelectronic detection means are associated.

The attachment of the flexible ballasting element may then be accomplished with rivets 35 which cross the tarpaulin 34 forming the doorway of the screen 12. This arrangement avoids possible rotation of the flexible ballasting element 14 which would have the consequence of interfering with the contact detection means.

A quite advantageous arrangement in applying the invention may be noted.

Provision may be made for placing the flexible ballasting element 14 which forms the bottom end of the screen, at a substantial distance from a reinforcing (either flexible or not) cross-bar of the screen. In practice, this distance may be of the order of 40 cm. This arrangement has quite a remarkable effect in the handling of a very frequent collision type which involves a handling vehicle and the bottom of the screen 12 when the latter is in the phase of downward movement. In this scenario, taking into account the great flexibility of the flexible ballasting element 14 of the screen 12, the screen 12 moves aside in front of the handling vehicle; the detection means associated with the flexible ballasting element 14 are activated and raising of the screen 12 is ordered by the control electronics 10. Taking into account the significant distance separating the flexible ballasting element 14 and the reinforcing cross-bar which is immediately parallel to it, the screen 12 is therefore only urged (i) in its portion which causes the less damage to the handling machine and to the load which the latter is transporting and (ii) in its most flexible portion which allows the integrity of the screen 12 to be preserved.

Moreover, provision may be made for leaving the lower portion of the screen free in its lower 40 cm. In other words, this lower portion which integrates the flexible ballasting element 14 is not guided sideways relatively to the uprights. During a collision with a person or a machine, the flexible ballasting element 14 deforms and triggers the detection means.

As this is shown in FIG. 4, according to a vertical sectional view of the screen, it may also be contemplated that the detection means be made with a tube in flexible material 23 which integrates an electric conductor 24; a rib 25 also provided with an electric conductor 26 is positioned inside this tube. The conductors 24 and 26 present inside the flexible tube 23 and on the rib 25 are each connected to a source of electric power which may for example be a battery loaded in the screen 12. In the case of a collision with an object which deforms the flexible tube 23, the rib 25 borne by the conductor 26 will come into contact with the wall of the tube which has the conductor 24, which closes the electric circuit formed by both electric conductors 24 and 26; the electric signal is then transmitted to the control electronics 10 of the screen 12.

The flexible tube 23 may either be placed under the flexible ballasting element 14 in a compartment formed by a PVC web panel, or it may be directly attached on the flexible ballasting element via a male/female connection of the dovetail type. The compartment 22 may itself be separated into two portions 22a and 22b which respectively receive the flexible ballasting element 14 and the detection means formed by the flexible tube 23. In this embodiment, the flexible ballasting element 14 and the detection means are independent.

After a collision, the screen 12 will naturally return into the plane formed by the uprights without the intervention of any operator, which represents a significant gain in productivity.

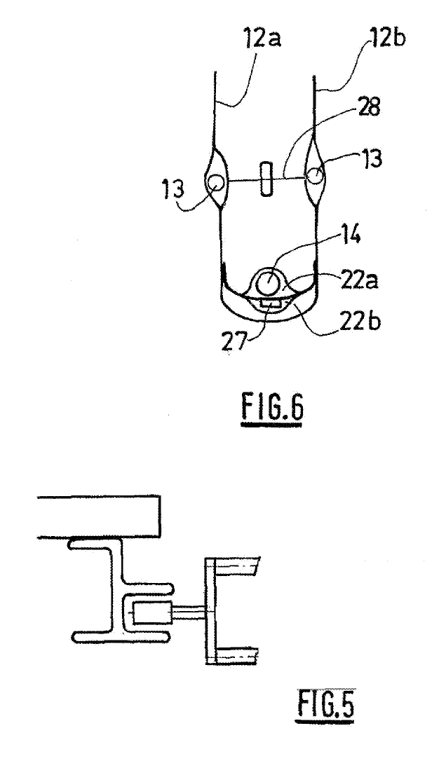

FIGS. 5 and 6 show that the invention may be applied to all the types of doors with a flexible screen, may for example be applied to doors, the flexible screen 12 of which comprises two tarpaulins 12a, 12b which are parallel, separate and maintained at a constant distance from each other by one or more spacers 28.

At its bottom transverse portion, the flexible screen 12 has a compartment 22 divided into two portions 22a and 22b which respectively receive the flexible ballasting bar 14 and detection means which may for example be formed by a sealed and deformable tube 27 in which pressurized air is stored and a pressure switch capable of measuring a change in pressure in the tube after a collision between the screen and a static or moving object.

It should be noted that the arrangement according to the invention providing association of detection means with a flexible ballasting element may be deployed on any type of flexible screen regardless of the guiding means applied for guiding the screen.

Moreover, it may be specified that the invention may relate to doors of small dimensions which are without any guiding means. In this door definition, the side edges of the screen 12 are simply engaged in slides provided in the uprights while a bar 29 with which contact detection means are associated, is suspended from the bottom of the screen. The collision is detected by flexure of the bar 29 which activates the detection means.

It is thus seen that with the invention it is possible to detect any contact which occurs with the screen of a fast door and autonomous handling of the collision is ensured since no human intervention is required after a collision. This point proves to be quite important since this means that the door is immediately operational after a collision.

1. A fast door which may close off an opening made in a partition comprising:
a structure having two vertical uprights in each of which a slide is arranged, and a top horizontal element forming a lintel, and
a flexible screen connected to the structure at the element forming a lintel by electromechanical means controlling lowering and raising of the screen so as to cause the screen to switch according to a normal screen trajectory parallel to a plane defined by the two slides, from a closed position in which the screen closes off the opening to an open position in which the screen clears access to the opening and vice versa,
means for controlling the electromechanical means controlling the movement of the screen,
wherein at a bottom transverse end, the flexible screen is fitted:
with a ballasting element which is rectilinear and flexible in a vertical plane and in a horizontal plane, capable of deforming and then resuming a rectilinear shape after contact with an object placed on the trajectory of the screen or encountering the latter, and
contact detection means positioned between the flexible ballasting element and the bottom free end of the screen connected to the control means and having a normal operating state and an abnormal operating state, the detection means being associated with the flexible ballasting element, and being capable of switching from the normal operating state to the abnormal operating state when there is contact of the screen with a static or moving object placed on the trajectory of the screen by a deformation of the flexible ballasting element or of the bottom free end of the screen, the change of the state of the detection means being converted into a signal which is transmitted to the control means with view to ordering the stoppage and/or raising of the screen towards its open position by resuming its normal trajectory, and this with no external intervention on the flexible ballasting element, nor on the control means, nor on the screen, nor on the slides.

2. The fast door according to claim 1, wherein the screen has at the bottom transverse end, a transverse compartment into which are integrated the flexible ballasting element and the collision detection means which are associated with the ballasting element.

3. The fast door according to claim 1, wherein the flexible ballasting element and the detection means which are associated with it are suspended from the bottom transverse end of the screen.

4. The fast door according to according to claim 1, wherein the detection means are positioned at the periphery and in proximity to the flexible ballasting element.

5. The fast door according to claim 4, wherein the detection means are positioned relatively to the flexible ballasting element on an angular sector of about 120° on either side of a lower generatrix of the flexible ballasting element or of the bottom edge of the screen.

6. The fast door according to according to claim 1, wherein the detection means switch from the normal operating state to the abnormal operating state by a deformation of said detection means upon deformation of the flexible ballasting element or of the bottom edge of the screen.

7. The fast door according to according to claim 1, wherein the detection means switch from the normal operating state to the abnormal operating state by breaking a beam which propagates in or parallel to the flexible ballasting element.

8. The fast door according to according to claim 1, wherein the flexible ballasting element has a length at most equal to a distance separating both slides.

9. The fast door according to according to claim 1, wherein the flexible ballasting element is engaged into a slide at either one or both of its ends.

10. The fast door according to according to claim 1, wherein the ballasting element comprises a helically wound metal wire which may be engaged into a sheath.

11. The fast door according to according to claim 1, wherein the detection means comprise a deformable sealed tube in which pressurized air is stored and a pressure switch capable of measuring a variation of pressure in the tube after a collision between the screen and a static or moving object.

12. The fast door according to according to claim 1, wherein the detection means comprise a tube in a deformable flexible material which integrates an electric conductor inside which a rib also provided with an electric conductor is positioned, the rib coming into contact with the electric conductor during a collision between the screen and a static or moving object.

13. The fast door according to according to claim 1, wherein the detection means comprise a transmitter and a receiver which define a beam inside or parallel to the flexible ballasting element, capable of being cut off upon contact between the screen and a static or moving object.

14. The fast door according to according to claim 2, wherein the detection means are attached on the flexible ballasting element by a male and female assembling system of the dovetail type.

15. The fast door according to according to claim 1, wherein the screen has at its bottom transverse end, a bottom transverse strip formed by a panel of flexible material folded over itself in order to delimit the transverse compartment in which the flexible ballasting element and the collision detection means are positioned.

16. The fast door according to claim 1, wherein the flexible ballasting element integrates a first conductor and at least one second conductor which come into contact with each other during a collision between the screen and a static or moving object.

17. The fast door according to claim 1, wherein the flexible ballasting element integrates a transmitter and a receiver which define a beam capable of being interrupted during a collision between the screen and a static or moving object.

18. The fast door according to claim 1, wherein the flexible ballasting element integrates a tube of air connected to a pressure switch, capable of changing state during a collision between the screen and a static or moving object.
